(19) United States
(12) Patent Application Publication
(10) Pub. No.: US 2006/0205399 A1
(43) Pub. Date: Sep. 14, 2006

(54) METHOD FOR SIMULATING COMMUNICATION FUNCTIONS OF A MOBILE PHONE ACCORDING TO A MARKUP LANGUAGE AND RELATED DEVICE THEREOF

(76) Inventors: Anku Jain, Gurgoan (IN); Vikram Salwan, New Delhi (IN); Arun Gupta, Faridabad (IN); Kuldeep Malik, Meerut Cant (IN)

Correspondence Address: NORTH AMERICA INTELLECTUAL PROPERTY CORPORATION, P.O. BOX 506, MERRIFIELD, VA, 22116, US

(21) Appl. No.: 11/306,567

(22) Filed: Jan. 3, 2006

Related U.S. Application Data
(60) Provisional application No. 60/641,100, filed on Jan. 3, 2005.

(30) Foreign Application Priority Data
Aug. 3, 2005 (IN) 2062/DEL/2005

(51) Int. Cl. H04Q 7/20

(52) U.S. Cl. 455/423

(57) ABSTRACT

A method for simulating communication functions of a mobile phone is disclosed. The method includes: storing information of a plurality of messages in a data file; receiving an incoming message; analyzing the incoming message to obtain a result; and generating an outgoing message in response to the incoming message according to the result and the information stored in the data file; wherein the incoming message and the information stored in the data file comply with a markup language.

### CROSS REFERENCE TO RELATED APPLICATIONS

This application claims the priority benefit of U.S. provisional application No. 60/641,100, which was filed on Jan. 3, 2005 and is included herein by reference.

### BACKGROUND

The invention is related to a method for simulation and a related device, and more particularly, to a method for simulating a portion of a communication device.

Simulators are computer programs, devices, or systems that simulate scenarios, devices, environments, and can actually simulate whatever requires simulation. Often the thing being simulated is a real-world event. This mode of simulation is often performed in a controlled environment. The controlled environment is a major advantage to utilization of a simulator. The utilization of the controlled environment simulators are critical for testing certain functionalities of computer programs, devices, and other systems that are otherwise difficult or absolutely impossible to properly, or at all, test in real-world conditions. Often another major advantage that makes the simulation option attractive is its ability to provide for a level of simplification. In other words, whatever the thing is that requires simulation can, be way of said simulation, be simplified in the simulation environment. These characteristics: controlled environments, and simplification capabilities, have been hallmarks of simulation for a long time. In fact, it has been a favorite of economists to utilize simulators to help make sense of our massively complex economies. Some events, procedures, or device, can be best tested when they are modeled within the simulation environment, thereby the testing takes place on the model rather than the actual thing (e.g., device, economic method, social patterns, network communications, and so on). Certain thing can only be examined or otherwise analyzed as models within a simulator, for example, the human brain, light-based circuits, and black holes. Modeling and simulating of an actual event, procedure, or device happens daily and countless people employ this method. Therefore, simulation is a critically important tool that is used in all fields of academic research and study.

One example of a class of systems that benefit from controlled environment simulation is embedded systems. Embedded systems are particularly difficult to test under real world conditions. For example, the developer of an embedded system must first utilize a cross compiler to generate a binary image for the embedded environment. Next, the developer must download or otherwise transfer the embedded software (e.g., now in binary format) to a target device (i.e., the device that will ultimately host the embedded system). Finally, it is possible to perform testing, however, the process thus far has already required a significant amount of time and expertise.

Please note that the embedded software mentioned earlier is the software being developed for a target device (i.e., the device that will host the embedded system). In other words, the software is being developed for the target device. Additional details regarding the related art embedded system development process are unnecessary, as the particulars of embedded systems development are well known to those of average skill in the art.

The testing and debugging process is already sufficiently difficult. As a given environment grows more complex, it becomes exceedingly difficult to perform testing and debugging operations. Of course, these are exactly the environments that most require meticulous attention to the testing process. For example, when an external network is associated with the developing system then additional time-consuming development effort is necessarily required because the system must be capable of responding to and interacting with the external network. For example, mobile phones under development require this additional effort to simulate their connectivity and interactions with the external network stimuli. The utilization of a phone simulator and a network simulator is a key component necessary for the successful testing of the complete functionality of a system. The testing of the system utilizing various simulators often occurs on a personal computer (PC) such as a Windows-based PC. To avoid the waste of money and effort it is important to perform complete simulation testing before the next step of using the embedded system with the actual device and network, for example, a mobile phone and a mobile phone network.

In some instances, the actual device or hardware is not available during the initial stages of development. In this case, simulators aid in jump-starting the development stages by simulating the actual hardware that is not yet available. The utilization of simulators in this case helps to compress parts of the development time line thereby reducing the overall development time of the final product. The mobile phone is a good example of a device that is commonly not yet available for development yet the development process is scheduled to proceed. As described in more detail later, it can be advantageous to utilize simulators even when the device is available.

Generally, simulators utilized for embedded devices are Windows-based applications executing on a common personal computer. These simulator applications are themselves developed for certain specific kinds of simulation. For example, a typical message-based simulator is built to satisfy the needs of the particular environment where message sequences, message types, message type values, data formats, and data values are important and necessary to the development, testing, and debugging processes. Briefly, the typical message-based simulator discussed here will comprise various layers including layers like a network stack and a man machine interface (MMI) layer. The network stack refers to one or more protocol layers that provide network connectivity, which can be implemented as hardware combined with associated software modules. Messages are simulated as arriving from an actual environment (i.e., the real-world), and sent to layers such as the MMI layer. The message format depends on the network stack to be simulated to test MMI layers with a simulated network stack. In other words, the message format and the network stack layers are tightly coupled structures. The details of the layers, especially those below the MMI layer are not discussed in detail here as this is well known to those of average skill in this art.

As is well known, any change in the network stack will involve changing the message sequences, the data structures associated with the message, the data associated with each of these data structures, and the development of a new user interface for the network simulator. A change in the simulator may vary from rewriting a few lines of code to completely rewriting the simulator. Obviously, this is not an optimal situation when minimizing development time is critical. For example, in the fast-paced market of mobile phone devices, the success of a particular mobile phone device may hinge on a narrow window of time when competing vendors are releasing their respective products to the market. Compressing the development time is crucial.

Please consider the following example. Vendor A provides a network stack having a specific format for network messages, such as: incoming call, or new message. The network simulator will operate as designed and continue to operate correctly, while the message data, the message sequence, and the message format all remain unchanged. However, if vendor A introduces even a slight change to, for example, the message sequence or the message format, this change necessitates code changes in the source code of the network simulator. Programmers and engineers must be invoked to revise the network simulator so that it accommodates Vendor A's modifications. This results in an extension of the development time line.

It is therefore necessary to provide an improved method and device for optimizing network and hardware simulation to solve the above-mentioned problems and in general to also provide improved simulation methods.

### SUMMARY

Therefore, the claimed disclosure provides a method for simulating communication functions of a mobile phone. The method comprises: first, storing information of a plurality of messages into a data file; then, receiving an incoming message; next, analyzing the incoming message to obtain a result; and also generating an outgoing message in response to the incoming message according to the result and the information stored in the data file. The incoming message and the information stored in the data file comply with a markup language.

In addition, the claimed disclosure provides a device for simulating communication functions of a mobile phone. The device comprises: a processor; and a storage device, coupled to the processor, for storing information about a plurality of messages, additionally, a network simulator engine program executable code, markup language manager program executable code, and a markup language engine program executable code for simulation when developing software of MMI layers on PC environment. The network simulator engine program executable code executed by the processor is utilized for receiving an incoming message, the markup language manager program executable code executed by the processor is utilized for analyzing the incoming message to obtain a result, the markup language engine program executable code executed by the processor is utilized for generating an outgoing message in response to the incoming message according to the result and the information stored in the storage device. The incoming message and the information stored in the storage device comply with a markup language.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an environment that will be utilized for further describing an embodiment of the present invention.

FIG. 2 is a block diagram illustrating a mobile phone simulator and a network simulator shown in FIG. 1.

FIG. 3 and FIG. 4 illustrate a flowchart showing a method for receiving an incoming message according to an embodiment of the present invention.

FIG. 5 is a flowchart showing a method for selecting an asynchronous message according to an embodiment of the present invention.

### DETAILED DESCRIPTION

Certain terms are used throughout the following description and claims to refer to particular system components. As one of average skilled in the pertinent art will appreciate, consumer electronic equipment manufacturers may refer to a component by variously different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

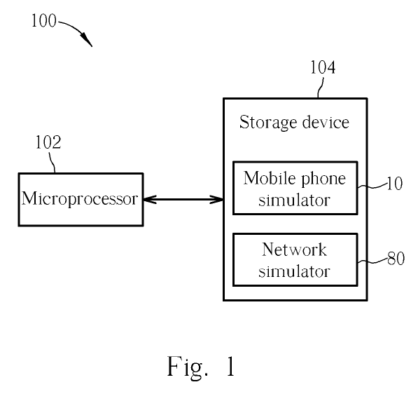

Please refer to FIG. 1. FIG. 1 shows an environment that will be utilized for further describing an embodiment of the present invention. As shown in FIG. 1, the device 100 for simulating communication functions of a mobile phone includes a microprocessor 102 and a storage device 104. The storage device 104 stores a mobile phone simulator 10 and a network simulator 80. It should be noted that the mobile phone simulator 10 and the network simulator 80 are composed of a plurality of program codes and that these program codes will be described in further detail hereinafter. After the device 100 (e.g., personal computer, laptop computer, personal digital assistant) is powered on, the microprocessor 102 loads and executes a specific operating system, and then executes program codes of the mobile phone simulator 10 and the network simulator 80 to simulate communication functions of a mobile phone. As illustrated below, the network simulator 80 is message-based. Therefore, it can be easily ported to other operating systems. Please note, the ability to port the network simulator 80 is an important feature because various operating systems each implement their own unique network stack layer configurations.

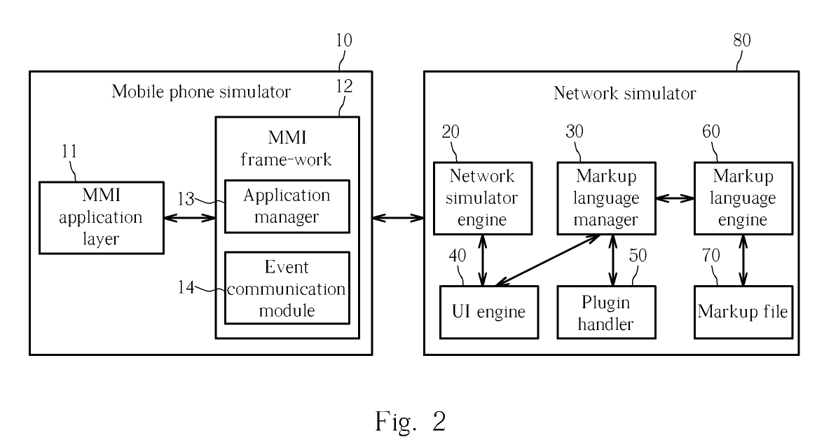

FIG. 2 is a block diagram illustrating the mobile phone simulator 10 and a network simulator 80 that simulates a network stack of the mobile phone shown in FIG. 1. In this embodiment, the network simulator 80 is a unique markup-language-based simulator. The network simulator 80 is network independent and highly configurable due to the characteristic of markup language. Please note that network simulator 80 can be, for example, a Windows-based application that is capable of simulating messages that would otherwise be generated by a network stack running on a mobile phone. Said Windows-based application is offer as an example and in no way as a limitation to the current disclosure. The man machine interface (MMI) of a mobile phone is simulated by the mobile phone simulator 10. As shown in FIG. 2, the phone simulator 10 comprises an MMI application layer 11 that further comprising items such as phone books, SMS, and call management features; an MMI framework component 12 that further comprises an application manager 13 and an event communication module 14, the MMI framework component 12 is responsible for controlling the application manager 13 and the event communication module 14; the application manager 13 is responsible for controlling the application that are executing on the mobile device, a cell phone for example; the event communication module 14 is responsible for receiving and sending messages to the network stack. In this embodiment, the functionality of the MMI application layer 11 and the MMI framework 12 is tested with the help of the network simulator 80. Obviously, other variations are possible and those variations are within the spirit of the present invention.

The formats of the messages that are sent by the network simulator engine 20 are highly dependent on the network stack to be simulated so that MMI layers can be tested for interacting with a simulated network stack. As one of average skill in the art knows, the network stack is a complex construction that is unforgiving in its interaction with peers. The network simulator engine 20 helps by simulating a network environment that does not otherwise exist on a PC (e.g., a standard off the shelf Windows personal computer) and does so without the need for the actual network or the actual mobile phone device. In short, the network simulator 80 simulates the network stack layers necessary for and utilized in communications activities with the above MMI layer.

General configuration markup language (GCML) is the primary component of network simulator 80. By way of example, and not limitation, the present disclosure utilizes the GCML. GCML is a powerful scripting markup language that is capable of implementing the functions required of a network message-based simulator. GCML allows the creation of new data types and data types of any size; the creation of new data structures; the creation of a subscript of different data types or data structures; the creation of new incoming messages, outgoing messages, and asynchronous messages; it provides for the timed response to messages, allows dynamic transfer of control to another module or object, offers dynamic user interface creation, allows multiple input sources; and the input source can originate from a GCML file that is stored in the markup file 70, an external UI pop-up generated by the UI engine 40, a file, or from the data values of an incoming message. The markup language manager 30 is responsible for coordinating these functions by interaction with the network simulator engine 20, the UI engine 40, the markup language engine 60 (that takes its input from the markup file 70), and the plugin handler 50. The details of GCML are well know to those of average skill in the art and are therefore omitted here for the sake of brevity.

The network simulator 80 overcomes limitations of the prior art simulators by utilizing GCML as its backend. Therefore, network simulator engine 20 is not tightly coupled to the network stack variables such as message formats and data objects. Rather, network simulator engine 20 creates messages according to the data values and data sets as specified in the GCML file stored in the markup file 70. Network simulator engine 20 then responds to the GCML file that is stored in the markup file 70 with a complete data packet. Later, a change in the device configuration such as the device's network stack or the operating system will not require major changes to the simulator code. For example, a mobile phone that is under development and not yet having finalized specifications is a device that will likely experience changes to its network stack or its real-time operating system (RTOS). A new GCML file is utilized to facilitate these changes. The new file is functionally the same as GCML file but with different content. For the purposes of the present invention, and to further illustrate the flexibility of the present invention, an original or a revise GCML file are both referred to as the GCML file and both are stored in the markup file 70. In other words, there is no need to reference a second GCML file.

Referring again to FIG. 2, the components of the network simulator 80 are as follows. The network simulator engine 20 is the main controlling engine in network simulator 80. The network simulator engine 20 initializes the markup language manager 30 and the UI engine 40. The network simulator engine 20 receives the messages coming from the mobile phone simulator 10 and passes them to the markup language manager 30. The markup language manager 30 is responsible for initializing and then further interacting with the markup language engine 60. On receiving an incoming message from the network simulator engine 20 the markup language manager 30 communicates with the markup language engine 60 to retrieve the information necessary for decoding the incoming message. The incoming message and the information stored in the storage device comply with a markup language which in this case is GCML and is used as an example and not intended to offer any limitation to the spirit of the present disclosure. Based on the information received from the markup language engine 60, the markup language manager 30 may route simulator control to the plugin handler 50 or it may build a response itself based on the parameters received in the incoming message. Further details include: the outgoing message may be an auto response mode message, in which case the outgoing message will correspond to an auto response mode stored in the plurality of message settings in the markup file 70. The markup language engine 60 will ensure that the outgoing message will utilize a default setting from said message settings. When an auto response message mode is not available then the outgoing message is generated according to a user selection. The markup language engine 60 provides these services by either generating the auto response message or when user input is needed the markup language engine 60 can display a plurality of candidate settings from the settings available in the markup file 70 thereby allowing the user to see and select from the plurality of settings, which are displayed by the UI engine of the simulator. Next, the markup language manager 30 passes the decoded message to the network simulator engine 20 and the network simulator engine 20 utilizes that message to transmit a response to the MMI layer. Finally, the markup language manager 30 passes any appropriate message information to the UI engine 40.

The UI engine 40 is responsible for controlling the graphical user interface display. The UI engine 40 is responsible for displaying incoming messages, outgoing messages, accepting input from a user, providing interfaces for adding new messages, new formats, new data lists, new data values, and other such information that is typically desirable to have resided in the mobile phone 10. The UI engine 40 is also responsible for creating a dynamic user interface. The markup language manager 30 provides the details of the dynamic user interface to the UI engine 40. Finally, the network simulator engine 20 is also responsible for receiving messages from the markup language manager 30 and passing them to the MMI layer.

The markup language manager 30 gives the plugin handler 50 control of the network simulator 80 when the message according to the GCML file stored in the markup file 70 indicates the need for an associated plugin. The plugin handler 50 will search for the appropriate function (i.e., plugin) then pass control to that particular plugin. Plugins are typically utilized in situations where the markup language, stored in the GCML file stored in the markup file 70, is not sufficiently able to satisfy the message requirements of the simulator. For example, the state management on a SIM for a GSM based handset requires a plugin. The plugin handler 50 can process incoming and outgoing messages. In the case of outgoing messages, the plugin handler 50 does not pass the message directly. It sends outgoing messages to the markup language manager 60, which forwards the outgoing messages to the network simulator engine. In other words, the plugin handler 50 will dynamically transfer control to an external DLL when the markup language indicates that the message requires an external component (i.e., plugin).

The markup language engine 60 is responsible for parsing the GCML file that is stored in the markup file 70 and then converting the contents of the GCML file into a plurality of objects. The objects are then also stored in the markup file 70 and are later accessed by the markup language manager 30 to collect information about the messages. The objects are loaded into a memory (not shown) at the start of the simulation operation when the markup language engine 60 is initialized.

The GCML file contains information about all of the incoming messages, the data formats associated with these messages, data lists associated with each format, and data values in each data list. The GCML file contains the GCML script (not shown). The GCML script is very powerful and well suited for utilization in the present invention simulator. It is utilized for many of its advantages, such as: GCML allows the addition of new functionalities without any changes to the simulator's source code. Specifically, new messages can be added for use with the simulator simply by adding new message tags. The newly added messages are easily integrated with the user interface (UI) allowing the user to select the newly added messages for response or asynchronous events. Additionally, the GCML script allows for the creation of data values, which define objects of different data types. A data value can originate from various sources, such as: a value in the incoming message, a value from a file, a value from a field in UI, or some data included in the GCML file. Another feature of GCML are data list. The data lists function as containers for different data values. A data list defines the complete set of values that are associated with a particular format of data. A format associates a data list to a data creation mechanism. The data creation mechanism can be a plugin, a (UI) pop up display, or it can originate from a data list. GCML also allows for the definition of the user interface details. Each UI pop up has a list of input variables and their data types. This allows setting the checks on UI pop up entry fields.

Additionally, the GCML script allows for a list of messages. Messages are classified into three categories as follows:

Incoming messages: these are messages that are received by the network simulator 80 from the network simulator engine 20 (or perhaps from the mobile phone simulator 10). They have a format associated with them. Incoming messages have at least a single or in other cases, multiple response messages associated with them.

Outgoing messages: these are messages that are sent as a response to the incoming messages. They have a format associated with them. Outgoing messages do not have any associated response message.

Asynchronous messages: these are the messages that originate from the network simulator engine 20. These messages also have a format associated with them. Finally, the last component is the memory (not shown). The memory is coupled to the markup language engine 60 and is utilized for the temporary storage of information such as when a plugin must store state information. The memory is otherwise also available to any other component of the network simulator 80 should said component require storage.

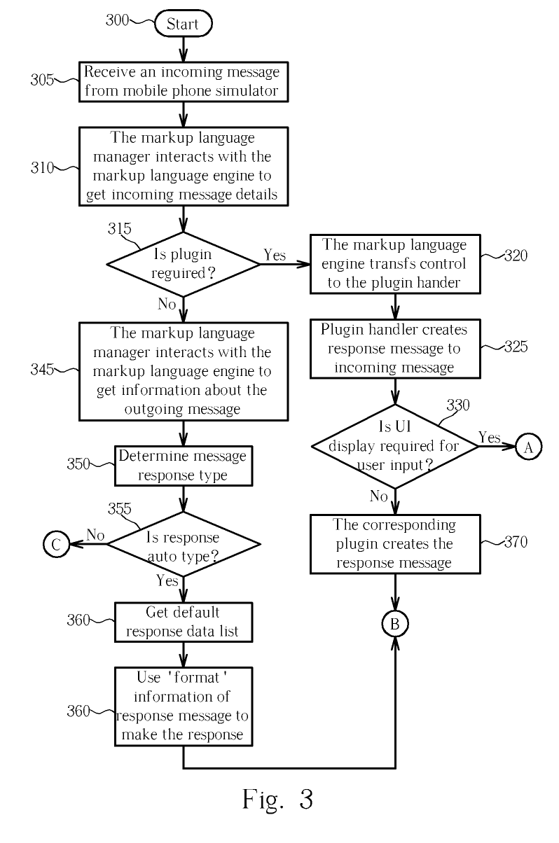

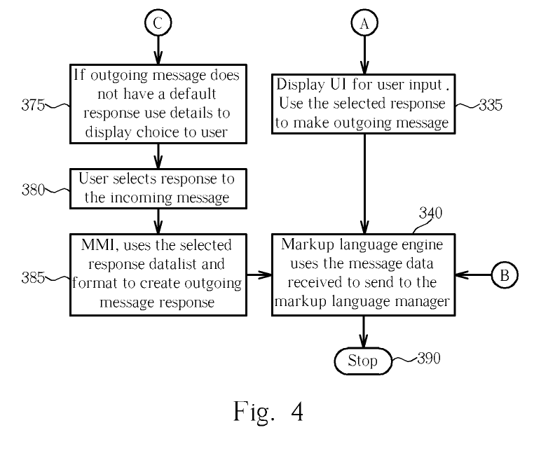

Please refer to FIG. 3, FIG. 4 and FIG. 2. FIG. 3 and FIG. 4 illustrate a flow diagram showing the present disclosure receiving an incoming message. Please note that the incoming message in this example is a non-asynchronous message. The network simulator engine 20 simulates that it receives a message. The network simulator engine 20 then passes the received message to the markup language manager 30. Here are the details of the flow:

Step 300: Start.

Step 305: Receive an incoming message from the mobile phone simulator 10.

Step 310: The markup language manager 30 interacts with markup language engine 60 to get details about the incoming message. The markup language engine 60 is able to provide the message details because it accesses the message information and message format data objects that were created at initialization of the network simulator 80 that reads a GCML file. The GCML file is prepared according to the network stack to be simulated.

Step 315: The markup language engine 60 determines if the incoming message requires an associated plugin. If a plugin is not associated with the incoming message then proceed to step 345.

Step 320: The markup language engine 60 transfers control of the network simulator 80 to the plugin handler 50.

Step 325: Check if user input is required? Then the plugin handler 50 creates a response message in response to the incoming message and sends the response message to the markup language manager 30. The plugin may require access to memory (not shown) for retrieving the previous state of the plugin.

Step 330: The plugin determines if a UI display is required for user input. If a UI display is not required then proceed to step 370.

Step 335: Display the UI popup or other UI element (e.g., window, menu, etc.) for user input and the selected response is then used by the plugin to create an outgoing message.

Step 340: The markup language engine 60 decodes the message details to send to the markup language manager 30. Proceed to step 390.

Step 345: The markup language manager 30 interacts with markup language engine 60 to get information about the outgoing message.

Step 350: Determine the message response type.

Step 355: If the message response type of the outgoing message is not an auto response type then proceed to step 375.

Step 360: Retrieve the default response data list.

Step 365: Utilize the format information of the response message to create the response. Proceed to step 340.

Step 370: The corresponding plugin creates the response message. Proceed to step 340.

Step 375: The outgoing message does not have a default response message therefore the outgoing message details such as formats, data sets, and data lists are retrieved by the markup language engine 60 from the markup file 70 utilizing the GCML compliant format.

Step 380: The user selects a response to the incoming message.

Step 385: The markup language manager 30 uses the selected response data list and format to create an outgoing message response. Proceed to step 340.

Step 390: Stop.

Regarding the flow of FIG. 3 and FIG. 4 please note these comments. Specifically, step 310 cites the use of GCML. This is by way of example only and not intended to be a limitation of the present disclosure. In fact, the network simulator 80 can work with other markup languages. The key concept that is disclosed is the loose coupling between the simulated hardware device and the mechanism utilized for offering the simulated device details. Because any markup language text (in a programming sense) can be easily modified to provide a new definition for a new or different working environment thereby defining the functionality of, for example, a mobile phone. Regarding step 325, it is well know to those of average skill in the art of this disclosure that the memory can be a small amount of Flash, etc. and can be utilized for advantageously storing data required by the plug-in such as a plug-in state. Markup languages are not always sufficiently able to provide state, especially from one execution instance to subsequent execution instance. Therefore, one motivation for utilizing a plug-in is for preserving state. Regarding step 355, the message types presented here are intended as examples and by no means set forth to limit the disclosure. In as much as the markup language is extensible thereby the present disclosure is also extensible. It is as easy to add or otherwise modify an element of the simulator as basic as the message types as it is to extend the functions of the simulated device as defined by the markup language.

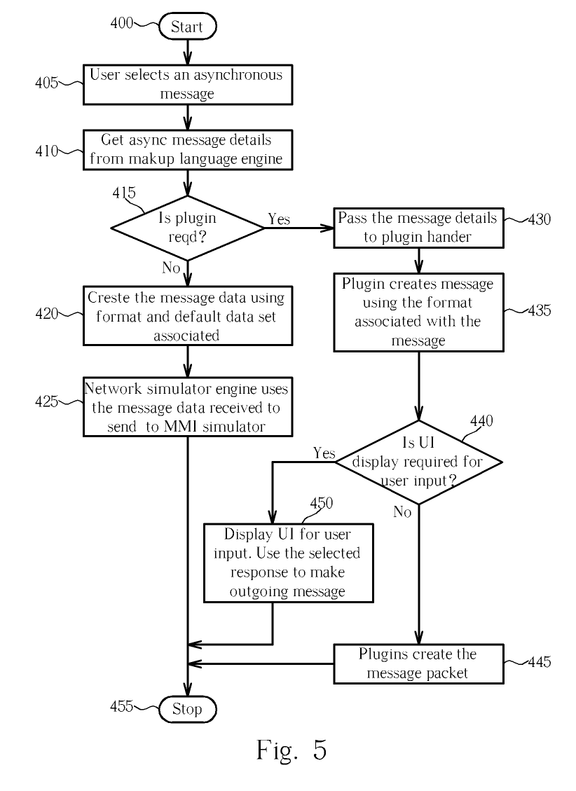

Please refer to FIG. 5. FIG. 5 illustrates the flow resulting from a user selecting an asynchronous message from the network simulator engine 20. Here are the details of the flow:

Step 400: Start.

Step 405: The user selects an asynchronous message.

Step 410: The markup language manager 30 interacts with markup language engine 60 to get details about the asynchronous message. The markup language engine 60 accesses the data objects that were created at initialization of the network simulator 80 by reading a GCML file that is designed for the network stack to be simulated.

Step 415: The markup language manager 30 checks whether the asynchronous message has a plugin associated with it. If a plugin is associated with the message then proceed to step 430.

Step 420: The asynchronous message details like formats and data sets are retrieved from the markup file 70 utilizing the markup language engine 60.

Step 425: The markup language manager 30 uses the default data list and format to create an outgoing message. Proceed to step 455.

Step 430: The markup language manager 30 transfers control of the network simulator 80 to the plugin handler 50 along with the message details.

Step 435: The plugin handler 50 creates a response message and sends it to the markup language manager 30. The plugin may access a memory (not shown) for retrieving a previous state.

Step 440: If the asynchronous message requires a UI display then proceed to step 455.

Step 445: The plugin creates the message. Proceed to step 455.

Step 450: The UI interface is displayed for user input and the selected data is then used to create a response message.

Step 455: Stop.

Regarding the flow of FIG. 5, please note these comments. Specifically, the operations of the steps shown in FIG. 5 and predominately similar to the steps shown and described in FIG. 3 and FIG. 4. Therefore, the redundant description will be omitted for the sake of brevity.

In summary, network simulator 80 is capable of simulating messages generated by a network stack running on a mobile phone. The network simulator 80 simulates the messages that are sent by the network stack to the MMI layers above. The network simulator 80 helps by simulating a network environment that does not otherwise exist on a PC and does so without the need for the actual network or the actual mobile phone device or hardware. The network simulator 80 achieves all of these objects by utilizing a markup language, e.g., GCML, as the backbone for defining the simulation environment. Since network simulator is easy to configure for another network or another device or both, it reduces the time to market for a new mobile phone device. As a result, minimal effort is needed on the simulator portion of the development process. For example, the present disclosure reduces the time and cost needed to get a product to market. With the ability of GCML to have dynamic UI controls, a core embedded company is no longer required to hire many UI developers. The network simulator 80 is not UI intensive. It creates its own user interface with a change in the base stack. This reduces the cost of development for the company. To further summarize, network simulator 80 is a strong test tool. In addition, the network simulator 80 places no restriction on the sequence of messages. Thus, it helps in simulating the negative scenarios and tests the behavior of the device in such situations. New testing scenarios can be created easily by adding more data sets in the messages and different kinds of asynchronous messages. Making minor and simple changes to the GCML file that is stored in the markup file 70 facilitates this.

GCML is selected as an example of a markup language that is a powerful scripting tool that is capable of encapsulating information for messages based on communications. However, utilization of an alternative markup language obeys the spirit of the present disclosure. Some of the powerful characteristics of GCML include: GCML provides for the definition of data types within the GCML markup language. A data type is similar to a data type in the C programming language. For example, each data type will have a name and size associated with it.

The present disclosure has many advantages over the related art due its integration of a markup language, specifically; the GCML integration was selected herein. For example, GCML provides for the setting of automatic in addition to manual responses to a message. An auto response does not require any user intervention. In addition, a user can set a data value for a message as a default response value. So, taking the case of an auto response message, the default response value of a message is sent to the MMI. The GCML allows timed responses to the MMI simulator. It affords the feature of timer creation (or multiple timer creations or instances) that can be linked to a message. This helps in situations where sending periodic indications to the MMI simulator is advantageous. A good example of utilization of a timer is the case wherein it is desirable to send a low battery signal every one minute. GCML allows multiple data input methods. A data can be generated from the following sources: user interface screen, the GCML file, and an external file. Additionally, data values can be defined by a plugin code or from an incoming message. The network simulator 80 leverages the flexibility of GCML to allow the transfer of control to another piece of code. The GCML file allows control transfer to a plugin. Plugins can be an external dll's or a piece of code compiled within the network simulator 80. Plugins contain the business logic, are only concerned about the input and output variables. A plugin is written to provide specific functionality required by a certain module. The plugin handler 50 in the network simulator 80 is responsible for transferring control to plugins when needed and for managing the data being sent and received from a plugin. The use of a markup language, such as GCML, helps to create not only network messages, but also any kind of messages received by MMI. These messages can be external indications, hardware related messages, and input and output related messages and indications. Thus network simulator 80 can be used to simulate not only network related functionality, but it also helps in adding other functionalities like memory storage, and general messages coming from hardware like audio and LED's. Furthermore, the markup language manager 30 helps to create UI screens based on the data sets in the markup file (the contents of the markup file 70 of the present disclosure). The markup language engine 60 takes the format as an input and creates a screen dynamically, based on the data values in the format. Thus new messages or a change in the formats and data values for a message does not require any change in the user interface. The network simulator 80 is easily ported to different operating systems and communication stacks. GCML contains data sizes and formats. The creation of new data types in GCML helps in simulating different stacks developed on different operating systems. Since the entire communication engine, the network simulator engine 20 of the present invention, is message based, and the messages are created through the markup file 70, changes in this file can easily help to port the system to new stack software. The network simulator 80 allows users to mark the most commonly used messages. This parameter is stored in the markup file 70. For example, this can provide the user with a toolbar that shows the most commonly used messages. A change in the markup language can also change messages to indicate an auto response. This facilitates the users to not being required to send responses to the messages they are not testing in the current setup. The network simulator 80 not only helps developers in testing there software during development phase, but it also helps the business development team to easily configure and present demonstrations to customers. The markup file 70 also helps the testing team to easily configure and test difficult real life scenarios like low network signal, low battery, no network signal, etc. Outside of the simulation environment given by the network simulator 80, these real world conditions are sometimes difficult to create and certainly time consuming. However, simulation by way of the markup language via the markup file 70 is very advantageous. The network simulator 80 can be used for creating message sequence charts. It helps in documentation by allowing the creation of message sequence charts for different network messages. The use of the markup file 70 allows the same network simulator 80 to be used for more then one stack. A change of markup file 70 shall easily allow the network simulator 80 to simulate a different network stack. These as well as additional objects and advantages of the present disclosure are achieved by providing a method for simulating the communication functions of a mobile phone according to a markup language and the related device thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for simulating communication functions of a mobile phone, the method comprising:
(a) storing information of a plurality of messages in a data file;
(b) receiving an incoming message;
(c) analyzing the incoming message to obtain a result; and
(d) generating an outgoing message in response to the incoming message according to the result and the information stored in the data file;
wherein the incoming message and the information stored in the data file comply with a markup language.

2. The method of claim 1, wherein step (d) further comprises:
detecting whether the outgoing message corresponds to an auto response mode;
when the outgoing message corresponds to the auto response mode, generating the outgoing message utilizing a default setting from the data file; and
when the outgoing message does not correspond to the auto response mode, generating the outgoing message according to a user selection.

3. The method of claim 2, wherein the step of generating the outgoing message according to the user selection comprises:
displaying a plurality of candidate settings from the data file; and
selecting one of the candidate settings to generate the outgoing message.

4. The method of claim 1, further comprising:
(e) detecting a plug-in code requirement of the incoming message, if the incoming message requires at least one plug-in code, executing the plug-in code according to the incoming message for determining the outgoing message, and if the incoming message does not require the plug-in code, proceeding with steps (c) and (d).

5. The method of claim 4, where step (e) further comprises:
detecting whether a user interface display is required;
when the user interface display is not required, set a preliminary outgoing message generated by the plug-in code to be the outgoing message; and
when the user interface display is required, generating the outgoing message according to a user selection.

6. The method of claim 5, wherein the step of generating the outgoing message according to the user selection comprises:
displaying the preliminary outgoing message and at least a previous outgoing message generated by a specific plug-in code; and
selecting one of the preliminary outgoing message and the previous outgoing message to be the outgoing message according to the user selection.

7. The method of claim 1, wherein the incoming message is an asynchronous message.

8. The method of claim 1, wherein the markup language is general configuration markup language (GCML).

9. A device for simulating communication functions of a mobile phone, the device comprising:
a processor; and
a storage device, coupled to the processor, for storing information of a plurality of messages, a network simulator engine program executable code, markup language manager program executable code, and a markup language engine program executable code, the network simulator engine program executable code executed by the processor being utilized for receiving an incoming message, the markup language manager program executable code executed by the processor being utilized for analyzing the incoming message to obtain a result, the markup language engine program executable code executed by the processor being utilized for generating an outgoing message in response to the incoming message according to the result and the information stored in the storage device;
wherein the incoming message and the information stored in the storage device comply with a markup language.

10. The device of claim 9, wherein the markup language engine program executable code, executed by the processor, is further utilized for:
detecting whether the outgoing message corresponds to an auto response mode;
when the outgoing message corresponds to the auto response mode, generating the outgoing message utilizing a default setting from the data file; and
when the outgoing message does not correspond to the auto response mode, generating the outgoing message according to a user selection.

11. The device of claim 10, wherein the markup language engine program executable code, executed by the processor, generates the outgoing message according to the user selection by:
displaying a plurality of candidate settings from the data file stored in the storage device; and
selecting one of the candidate settings to generate the outgoing message.

12. The device of claim 9, wherein the markup language manager program executable code, executed by the processor, is further utilized for:
detecting a plug-in code requirement of the incoming message, if the incoming message requires at least one plug-in code, executing a plug-in handler program execution code for executing the plug-in code according to the incoming message for determining the outgoing message.

13. The device of claim 12, wherein the markup language manager program executable code, executed by the processor, is further utilized for:
detecting whether a user interface display is required;
when the user interface display is not required, set a preliminary outgoing message generated by the plug-in code to be the outgoing message; and
when the user interface display is required, executing a UI engine program executable code for generating the outgoing message according to a user selection.

14. The device of claim 13, wherein the markup language engine program executable code, executed by the processor, generates the outgoing message according to the user selection by:
displaying the preliminary outgoing message and at least a previous outgoing message generated by a specific plug-in code; and
selecting one of the preliminary outgoing message and the previous outgoing message to be the outgoing message according to the user selection.

15. The device of claim 9, wherein the incoming message is an asynchronous message.

16. The device of claim 9, wherein the markup language is general configuration markup language (GCML).
